(19) United States
(12) Patent Application Publication
(10) Pub. No.: US 2024/0377693 A1
(43) Pub. Date: Nov. 14, 2024

(54) OPTICAL DEVICES AND METHODS FOR ADJUSTABLE LIGHT ATTENUATION BASED ON ANISOTROPIC MATERIALS

(71) Applicant: Meta Platforms Technologies, LLC, Menlo Park, CA (US)

(72) Inventors: Jasmine Soria SEARS, Portland, OR (US); Francis Lawrence LEARD, Sudbury, MA (US); Olga Vladimirovna BARYKINA-TASSA, San Mateo, CA (US); Afsoon JAMALI, Issaquah, WA (US)

(21) Appl. No.: 18/663,055

(22) Filed: May 13, 2024

Related U.S. Application Data
(60) Provisional application No. 63/501,669, filed on May 11, 2023.

(51) Int. Cl. G02F 1/166; G02F 1/1343; G02F 1/1675

(52) U.S. Cl. CPC G02F 1/166; G02F 1/134309; G02F 1/1675

(57) ABSTRACT

An optical device includes a first set of electrodes; a second set of electrodes distinct and separate from the first set of electrodes; and a medium located between the first set of electrodes and the second set of electrodes. The medium includes a mixture of: liquid crystals and magnetic microstructures. The optical device is coupled with one or more magnetic field generators for switchably providing a magnetic field for orienting the magnetic microrods in the medium independently from the orientations of the liquid crystals. An optical device that includes a switchable optical cell and carbon nanotubes located within the switchable optical cell is also described.

### RELATED APPLICATIONS

This application claims the benefit of, and priority to, U.S. Provisional Patent Application Ser. No. 63/501,669, entitled “Anisotropic Materials for Switchable Optical Cells” filed May 11, 2023, which is incorporated by reference herein in its entirety.

### TECHNICAL FIELD

This application relates generally to optical devices and, more specifically, to optical devices that provide dimming effects based on an electrochromic effect.

### BACKGROUND

Electro-optic devices are widely used in optical applications. By changing the optical properties of a material, electro-optic devices can modulate light based on applied electrical signals. An example of electro-optics devices includes spatial light modulators, which can change the polarization of light.

### SUMMARY

Electrochromic devices have been used to provide dimming effects (e.g., attenuation of the transmitted light). However, conventional electrochromic devices tend to have slow response time. In addition, the transmission spectrum of electrochromic devices is influenced by the thickness of electrodes and electrolyte layers, and variations in the thicknesses of the electrodes and electrolyte layers can affect the performance of electrochromic devices.

Such challenges and other limitations may be alleviated by optical devices and methods described herein.

In accordance with some embodiments, an optical device includes a first optically dimmable filter that includes a first set of one or more electrodes; a second set of one or more electrodes distinct and separate from the first set of one or more electrodes; and a medium located between the first set of one or more electrodes and the second set of one or more electrodes, the medium including one or more electrochromic materials and liquid crystals.

In accordance with some embodiments, an optical device includes a first optically dimmable filter that includes a first spacer having a first thickness; a second spacer having a second thickness distinct from the first thickness; a first set of one or more electrodes; a second set of one or more electrodes. The first set of one or more electrodes and the second set of one or more electrodes are separated by the first spacer and the second spacer. The first optically dimmable filter includes a medium located between the first set of one or more electrodes and the second set of one or more electrodes, the medium including one or more electro-optic materials.

In accordance with some embodiments, a wearable display device includes a display and any optical device described herein. The display is positioned to receive light transmitted through the optical device.

The disclosed optical devices and methods may replace conventional optical devices and methods. The disclosed optical devices and methods may complement conventional optical devices and methods.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1A-1B and 2A-2B are schematic diagrams illustrating an optical device in accordance with some embodiments.

FIG. 3 is a schematic diagram illustrating example profiles of magnetic fields and electrical field applied to an optical device in accordance with some embodiments.

FIGS. 4A-4H are schematic diagrams illustrating optical devices in accordance with some embodiments.

FIGS. 5A and 5B are schematic diagrams illustrating optical devices in accordance with some embodiments.

FIG. 6 is a prophetic example showing changes in optical contrast provided by photochromic materials and carbon nanotubes.

FIG. 7 is a perspective view of a display device in accordance with some embodiments.

FIG. 8 is a block diagram of a system including a display device in accordance with some embodiments.

FIG. 9 is an isometric view of a display device in accordance with some embodiments.

These figures are not drawn to scale unless indicated otherwise.

### DETAILED DESCRIPTION

As described above, conventional electrochromic devices may have slow response time. For example, electrochromic devices having a response time (e.g., a switching time) in the range of 2 to 40 seconds may be incompatible with, or have limited applications in, a dynamic display apparatus. For example, wearable display devices may require an optically dimmable device with less than 100 millisecond response time for adjusting dimmed regions in response to changes in the environment and displayed content without perceivable delays.

In addition, the transmission spectrum of electrochromic devices is influenced by the thickness of electrodes (e.g., anode and cathode) and electrolyte layers, and variations in the thicknesses of the electrodes and electrolyte layers can affect the transmission spectrum of electrochromic devices.

Furthermore, although cathodes and anodes are often made of optically transparent materials, such materials may have a non-flat absorption spectrum, leading to a color tint in electrochromic devices even when the electrochromic devices are in a clear state (e.g., a low-absorption state).

Optical devices described herein alleviate such challenges. Such optical devices may be used in wearable display devices, such as augmented reality or mixed reality devices. For example, liquid crystalline-based electrolytes can be used to reduce the response time. In addition, a spacer (e.g., a spacer based on an elastomer) allows a better control of a thickness of the electrolyte layer, which provides mechanical stability and controlled adjustment of the response time. Furthermore, the optical devices described herein may have lower absorption than conventional dimmable devices and reduce a color tint associated with certain conventional devices.

Such optical devices may be used for providing global dimming (dimming across an entire aperture of the optical device) or local dimming (dimming across only a portion of an aperture of the optical device) in wearable display devices. In addition, such optical devices may be used in settings other than with wearable display devices, such as in windows for vehicles or buildings.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

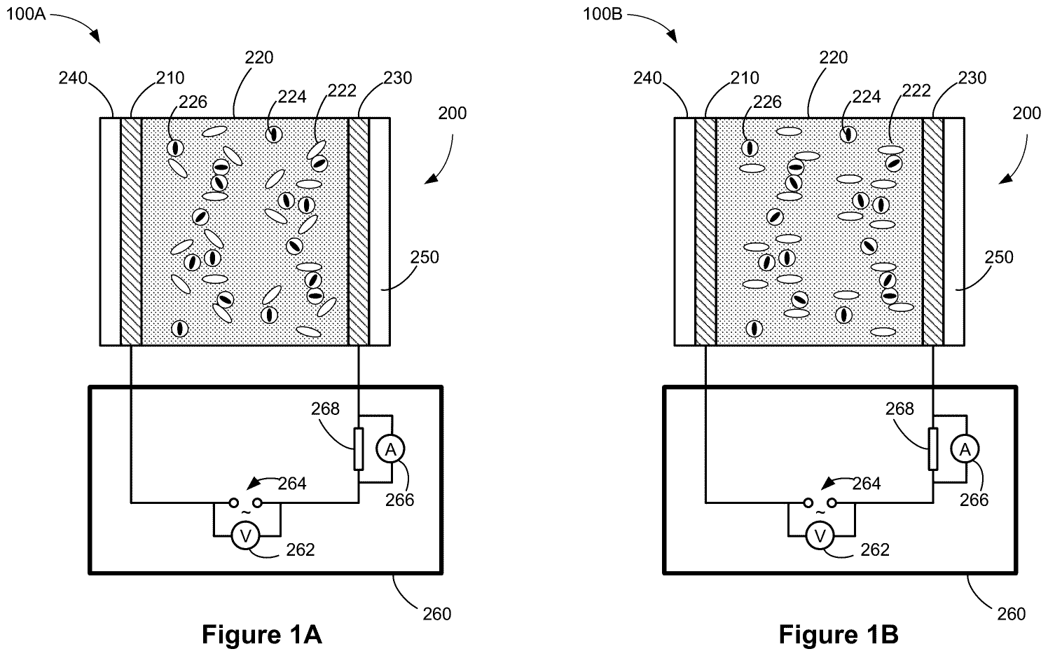

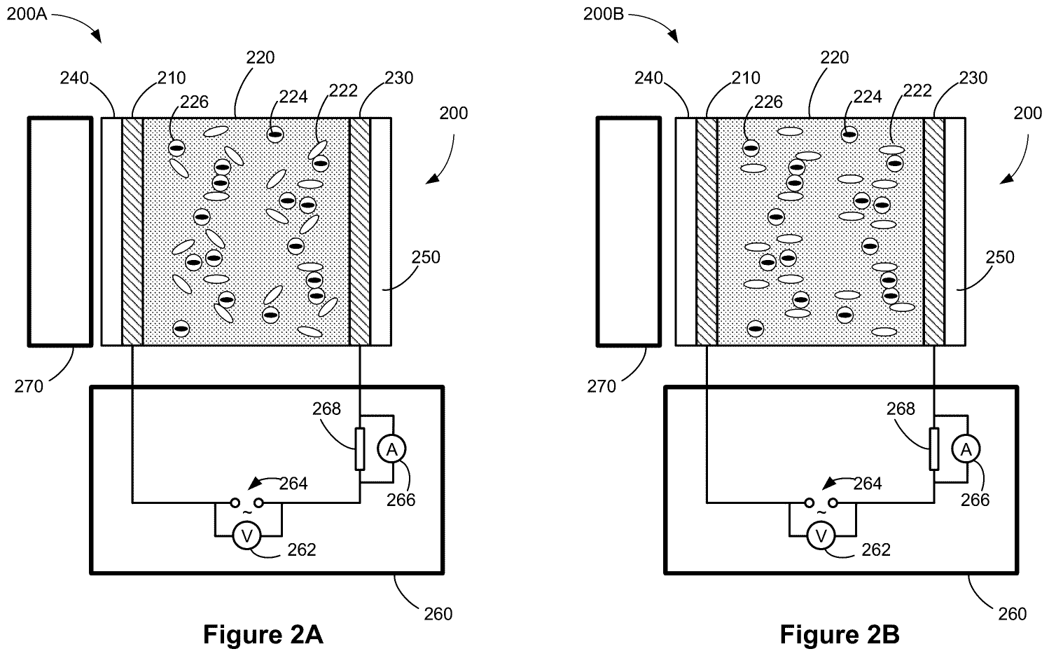

FIGS. 1A-1B and 2A-2B are schematic diagrams illustrating modes 100A, 100B, 200A, and 200B of operation for an optical device 200 (or a portion of the optical device that operates as a dimmable filter) that includes liquid crystals 220 and magnetic microstructures 224, in accordance with some embodiments.

The optical device 200 includes a first electrode 210. The first electrode 210 may provide an electrical field to a medium 220 located adjacent to the first electrode 210.

FIGS. 1A-1B and 2A-2B also show that the optical device 200 includes a second electrode 230. In some embodiments, the second electrode 230 is distinct and separate from the first electrode 210.

The optical device 200 also includes a first substrate 240. In some embodiments, the first substrate 240 is located adjacent to the first electrode 210 (e.g., the first electrode 210 is located adjacent to the first substrate 240).

In some embodiments, the first electrode 210 and the second electrode 230 are transparent electrodes. For example, the first electrode 210 and the second electrode 230 are transparent to visible wavelengths of light. In some embodiments, the first electrode 210 and the second electrode 230 are based on transparent conductive oxide (TCO) materials (e.g., indium tin oxide (ITO), fluorine doped tin oxide (FTO), or fluorine doped zinc oxide (FZO), etc.). In some embodiments, the first electrode and the second electrode are based on carbon nanotubes and/or graphene.

FIGS. 1A-1B and 2A-2B also show that the optical device 200 further includes a second substrate 250. In some embodiments, the second substrate 250 is located adjacent to the second electrode 230 (e.g., the second electrode 230 is also located adjacent to the second substrate 250).

In some embodiments, the first substrate 240 and/or the second substrate 250 are made of, or include, an optically transparent material, such as glass or optically transparent plastic (e.g., polyethylene terephthalate (PET)).

In some embodiments, the second substrate 250 is distinct and separate from the first substrate 240. This allows the first substrate 240 and the second substrate 250 to define a cavity between the first substrate 240 and the second substrate 250.

In some embodiments, the distance between the first substrate 240 and the second substrate 250 is 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or within an interval between any two of the forementioned distances. In some embodiments, the distance between the first substrate 240 and the second substrate 250 is greater than 5 mm.

As shown in FIGS. 1A-1B and 2A-2B, in some configurations, the medium 220 is located in the cavity.

In some embodiments, the medium 220 includes the liquid crystals 222 and the magnetic microstructures 224. In some embodiments, the liquid crystals 222 are or include nematic liquid crystals (e.g., 4-cyano-4′-pentylbiphenyl, 4-pentyl-4′-cyanobiphenyl, HTW106700-100, or HFW59200-200). In some embodiments, the liquid crystals 222 are or include twist-bend chiral nematic liquid crystals. In some embodiments, the liquid crystals 222 are or include polymer dispersed liquid crystals.

In some embodiments, the magnetic microstructures 224 include ferromagnetic materials (e.g., iron, cobalt, or nickel, or alloys or compounds containing iron, cobalt, or nickel). In some embodiments, a respective magnetic microstructure of the magnetic microstructures 224 has a shape of a microrod (e.g., a rod having a characteristic size on the order of a micron). For example, in some embodiments, a microrod has a diameter of 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50μ, 55 μm, 60 μm, 65 μm, 70 μm, 75 μm, 80 μm, 85 μm, 90 μm, 95 μm, 100 μm, or within an interval between any two of the forementioned distances. In some embodiments, the diameter of the microrod is greater than 100 μm. In some embodiments, a microrod has a length of 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50μ, 55 μm, 60 μm, 65 μm, 70 μm, 75 μm, 80 μm, 85 μm, 90 μm, 95 μm, 100 μm, or within an interval between any two of the forementioned distances. In some embodiments, the length of the microrod is greater than 100 μm.

In some embodiments, the magnetic microstructures 224 are at least partially coated with a coating 226. The coating 226 reduces clumping of the magnetic structures 224. In some embodiments, the magnetic microstructures 224 are encapsulated by the coating 226. In some embodiments, the coating 226 includes, or consists of, a transparent and non-magnetic materials (e.g., SiO₂, TiO₂, etc.).

In some embodiments, the optical device is electrically coupled with an electrical source 260. The electrical source 260 may provide a voltage or current to the optical device (e.g., across or between the first electrode 210 and the second electrode 230). For example, in some embodiments, the first electrode 210 and the second electrode 230 are electrically coupled with the electrical source 260. In some embodiments, the optical device includes the electrical source 260. In some embodiments, the electrical source 260 is not part of the optical device.

As shown in FIGS. 1A-1B and 2A-2B, in some embodiments, the electrical source 260 includes one or more voltage sources 262 and 264. In some embodiments, the electrical source 260 includes one or more current sources 266. In some embodiments, the electrical source 260 includes one or more voltage sources 262 and 264 and one or more current sources 266. In some embodiments, the electrical source 260 includes one or more voltage sources 262 and 264 without one or more current sources 266. In some embodiments, the electrical source 260 includes one or more current sources 266 without one or more voltage sources 262 and 264.

In some embodiments, the electrical source 260 includes an electrical power storage (e.g., a battery or a capacitor).

As shown in FIGS. 1A-1B and 2A-2B, in some embodiments, the one or more current sources 266 are electrically connected in parallel to one or more impedances 268 (e.g., resistors). In some embodiments, one or more current sources are electrically connected in parallel.

As shown in FIGS. 1A-1B and 2A-2B, in some embodiments, the one or more voltage sources 262 and 264 are electrically connected in parallel (e.g., the voltage source 262 is electrically connected in parallel to the voltage source 264). In some embodiments, the one or more voltage sources 262 and 264 are electrically connected in series. In some embodiments, the one or more voltage sources 262 and 264 include a direct-current voltage source. In some embodiments, the one or more voltage sources 262 and 264 include an alternating-current voltage source (or a dynamic voltage source that provides voltages in a non-sinusoidal pattern). In some embodiments, the one or more voltage sources 262 and 264 include both a direct-current voltage source and an alternating-current voltage source (or a dynamic voltage source).

In some embodiments, the electrical source 260 provides a first electrical input V1 (e.g., a zero-voltage input or an electrical input below a predefined electrical threshold, such as a voltage threshold) across the first electrode 210 and the second electrode 230 at a first time (e.g., while the optical device is in a first mode 100A of operation as shown in FIG. 1A). Such electrical input does not cause rearrangement of the liquid crystals 222 within the medium 220. As a result, the optical device may have a first set of optical properties.

In some embodiments, the electrical source 260 provides a second electrical input V2 (e.g., a non-zero voltage input or an electrical input above the predefined electrical threshold, such as the voltage threshold) across the first electrode 210 and the second electrode 230 at a second time (e.g., while the optical device is in a second mode 100B of operation as shown in FIG. 1B). Such electrical input causes rearrangement of the liquid crystals 222 within the medium 220. As a result, the optical device may have a second set of optical properties distinct from the first set of optical properties.

Notably, FIGS. 1A and 1B illustrate that the rearrangement of the liquid crystals 222 does not substantially affect the orientation of the magnetic microstructures 224 (e.g., the rearrangement of the liquid crystals 222 does not affect the orientation of the magnetic microstructures 224). Instead, the orientation of the magnetic microstructures 224 may be adjusted independently from the orientation of the liquid crystals 222 by providing a magnetic field.

FIGS. 2A and 2B illustrate that the optical device 200 includes, or is coupled with, a magnetic source 270. In some embodiments, the magnetic source 270 includes a magnetic coil, which controllably provides a magnetic field (e.g., provides a magnetic field at a first time and forgoes providing the magnetic field at a second time distinct from the first time). In some embodiments, the magnetic source 270 includes a meta resonator.

In some embodiments, the magnetic source 270 provides a first magnetic field (e.g., a zero-magnetic field or a magnetic field below a predefined magnetic threshold) at a first time (e.g., while the optical device is in a mode 100A or 100B of operation as shown in FIGS. 1A and 1B). Such magnetic field does not cause rearrangement of the magnetic microstructures 224 within the medium 220.

In some embodiments, the magnetic source 270 provides a second magnetic field (e.g., a non-zero magnetic input or a magnetic field above the predefined magnetic threshold) at a second time (e.g., while the optical device is in a mode 200A or 200B of operation as shown in FIGS. 2A and 2B). Such magnetic field causes rearrangement of the liquid crystals 222 within the medium 220.

FIG. 2A is similar to FIG. 1A in that the liquid crystals 222 are arranged in random directions.

FIG. 2B is similar to FIG. 2A except that FIG. 2B illustrates a state where the second electrical field is provided by the electrical source 260. As a result, the liquid crystals 222 are rearranged (e.g., along the direction from the electrode 210 to the electrode 230) in a manner similar to the liquid crystals 222 shown in FIG. 1B.

In some cases, FIG. 2A represents a state where the optical device provides a third set of optical properties (which may be distinct from the first set of optical properties and the second set of optical properties), and FIG. 2B represents a state where the optical device provides a fourth set of optical properties distinct from the third set of optical properties (where (the fourth set of optical properties may also be distinct from the first set of optical properties and the second set of optical properties).

For example, the optically dimmable filter can provide (i) a first transmittance (e.g., a low transmittance, such as 0%, 0.1%, 1%, 2%, 3%, 4%, 5%, 10%, 15%, 20%, 25%, 30%, 35%, 40%, 45%, or 49%, or within any interval between any two of the aforementioned values) while the optically dimmable filter or the optical device is in a particular state (e.g., the first state) and (ii) a second transmittance (e.g., a high transmittance, such as 100%, 99.9%, 99%, 98%, 97%, 96%, 95%, 90%, 85%, 80%, 75%, 70%, 65%, 60%, 55%, or 50%, or within an interval between any two of the aforementioned values) while the optically dimmable filter or the optical device is in a different state (e.g., the second state or the third state)). In some embodiments, the first transmittance is a first total transmittance. In some embodiments, the second transmittance is a second total transmittance.

Although FIGS. 1A-1B and 2A-2B represent two modes of operation for the optical device (e.g., an “on” state and an “off” state or vice versa) in terms of either an electrical field or a magnetic field, in some embodiments, the opaqueness of the optical device (or the optically dimmable filter) may be switched to three or more distinct states (e.g., low or no opaqueness, medium opaqueness, and high opaqueness) based on the electrical field or the magnetic field.

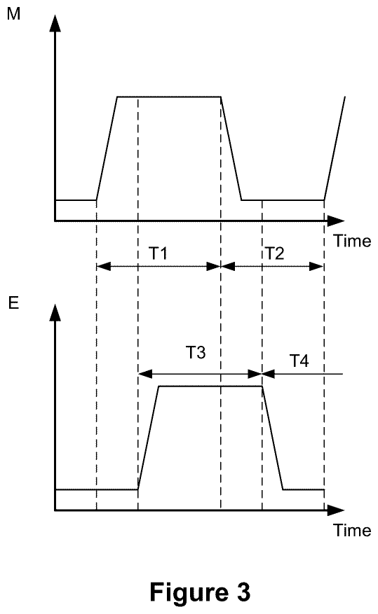

FIG. 3 is a schematic diagram illustrating example profiles of magnetic fields and electrical field applied to an optical device in accordance with some embodiments.

FIG. 3 shows that the magnetic field is applied over a time window T1 and the magnetic field is removed over a time window T2 and that the electrical field is applied over a time window T3 and the electrical field is removed over a time window T4. As shown in FIG. 3, the time window T1 partially (but not completely) overlaps with the time window T3, and the time window T2 partially (but not completely) overlaps with the time window T3 and the time window T4.

In some embodiments, the time window T1 completely overlaps the time window T3. In some embodiments, the time window T2 completely overlaps the time window T4.

In some embodiments, the time window T1 does not overlap with the time window T3. In some embodiments, the time window T1 does not overlap with the time window T4. In some embodiments, the time window T2 does not overlap with the time window T3. In some embodiments, the time window T2 does not overlap with the time window T4.

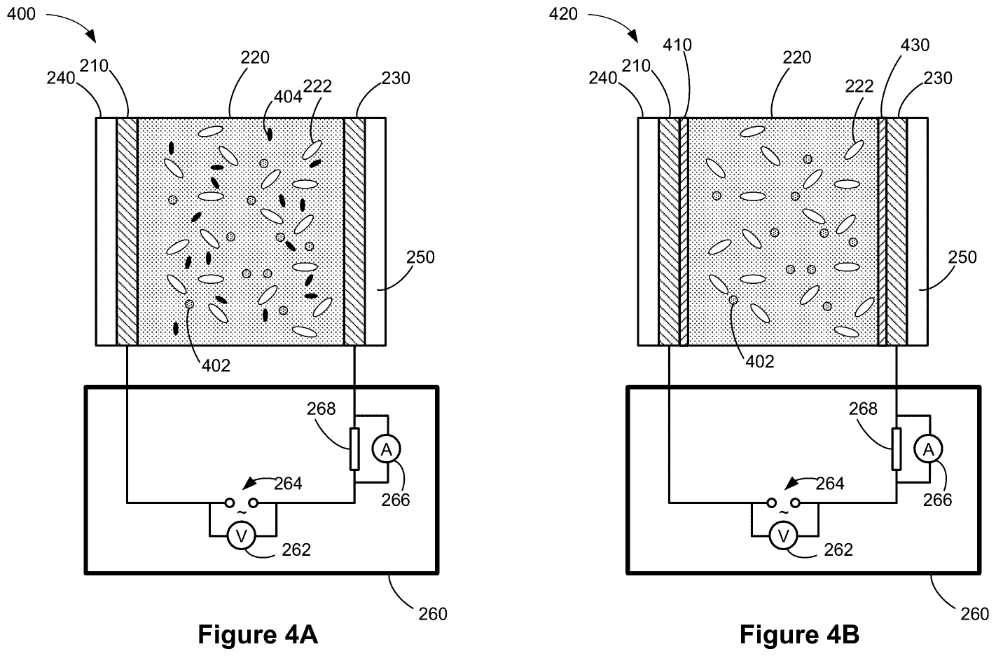

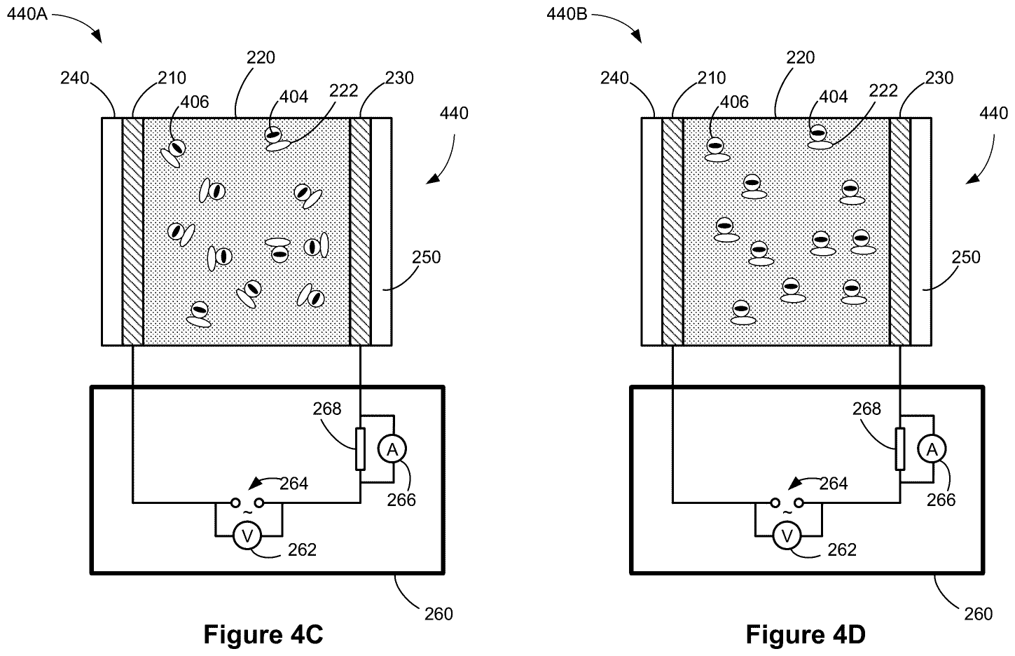

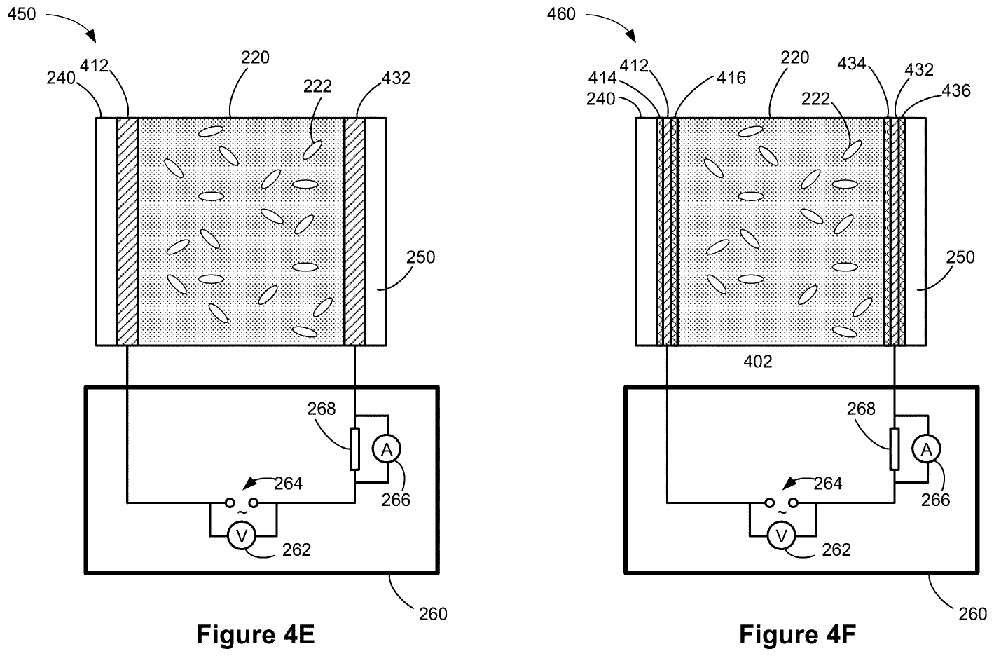

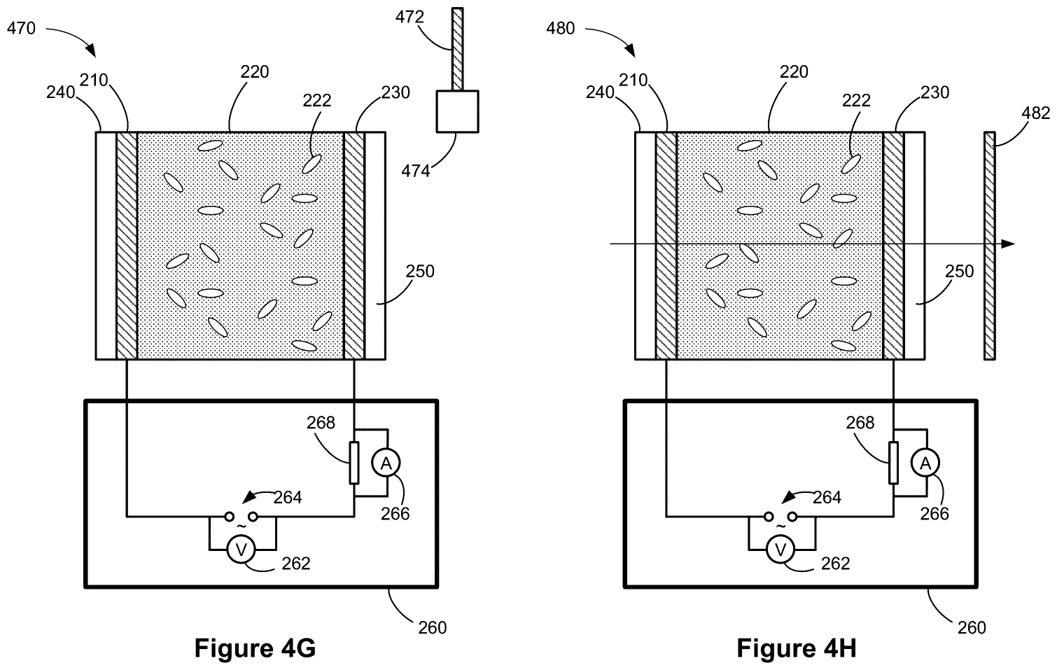

FIGS. 4A-4H are schematic diagrams illustrating optical devices in accordance with some embodiments.

FIG. 4A illustrates an optical device 400, which is similar to the optical device 200 described with respect to FIG. 1A except that the optical device 400 includes carbon nanotubes 404 instead of (or in addition to) magnetic microstructures 224. The carbon nanotubes 404 serves as dyes (e.g., dichroic dyes, such as guest dichroic dyes in a guest-host liquid crystal cell).

In some embodiments, as shown in FIG. 4A, the optical device 400 includes one or more photochromic materials 402. Examples of photochromic materials 402 include diarylethenes, azobenzenes, triarylmethanes, stilbenes, azastilbenes, nitrones, fulgides, spiropyrans, naphthopyrans, spirooxazines, or quinones. Other examples of photochromic materials 402 include inorganic photochromics, such as silver halides (e.g., silver chloride), zinc halides, or yttrium oxyhydride. US 2021/0103180 A1, entitled “Photochromic Optical Element,” and US 2022/0221754 A1, entitled “Photochromic Dye and Liquid Crystal Optical Element,” both of which are incorporated by reference herein in their entireties, provide additional details of photochromic materials.

In some configurations, the presence of carbon nanotubes 404 in the medium along with the photochromic materials 402 facilitate heat dissipation from the photochromic materials 402. In some embodiments, the amount (or concentration) of carbon nanotubes 404 is selected to increase the heat dissipation from the photochromic materials 402.

FIG. 4B illustrates an optical device 420, which is similar to the optical device 400 described with respect to FIG. 4A except that the optical device 420 includes one or more layers of carbon nanotubes (e.g., layers 410 and 430). The layer(s) of carbon nanotubes may facilitate heat dissipation from the optical device 420. In some embodiments, instead of, or in addition to, the one or more layers of carbon nanotubes, carbon nanotubes are coupled with photochromic materials. The carbon nanotubes coupled with the photochromic materials also facilitates heat dissipation from the photochromic materials, which may improve the transition time for the photochromic materials.

FIGS. 4C and 4D illustrate two modes 440A and 440B of operation for an optical device 440 in accordance with some embodiments. In the optical device, the liquid crystals 222 are coupled with the carbon nanotubes 404. In some embodiments, the liquid crystals 222 are coupled with the carbon nanotubes 404 via one or more couplers 406 (e.g., a chemical bond or a physical encapsulation).

In FIG. 4C, the electrical source 260 provides no electrical input (or an electrical input below a threshold) so that the liquid crystals 222 and the coupled carbon nanotubes 404 are randomly arranged. In FIG. 4D, the electrical source 260 provides an electrical input above a threshold so that the liquid crystals 222 are rearranged (along a line extending from the electrode 210 to the electrode 230). This also causes rearrangement of the coupled carbon nanotubes 404.

FIG. 4E illustrates an optical device 450, which is similar to the optical device 420 except that, instead of having one or more layers 410 and 430 of carbon nanotubes, one or more electrodes 412 and 432 include carbon nanotubes. In some embodiments, one or more electrodes 412 and 432 are made of carbon nanotubes. In some embodiments, the optical device 450 includes photochromic materials 402. In some embodiments, the one or more layers 410 and 430 of carbon nanotubes operate as transparent conductive electrodes. In some embodiments, the one or more layers 410 and 430 of carbon nanotubes operate as a color compensator. For example, a high yellow index in other optical components is compensated by an absorption spectrum of the one or more layers 410 and 430 of carbon nanotubes.

FIG. 4F illustrates an optical device 460, which is similar to the optical device 450 except that each of electrodes 412 and 432 is located between two dielectric layers (e.g., electrode 412 is located between dielectric layers 414 and 416 and electrode 432 is located between dielectric layers 434 and 436).

FIG. 4G illustrates an optical device 470, which is similar to the optical device 450 except that the optical device 470 includes, or is located adjacently to, an antenna 472. The antenna 472 is electrically coupled with a receiver 474. In some embodiments, the antenna 472 includes carbon nanotubes. In some configurations, this reduces the interference caused by an antenna that does not include carbon nanotubes (e.g., antenna made of a metallic material). In some embodiments, instead of having an antenna that is separate from the optical device, a layer of carbon nanotubes (e.g., the electrode 412 or 432 in FIG. 4E or 4F) is used as an antenna. Because the layer of carbon nanotube may have a low sheet resistance, which reduces an interference caused by the antenna.

FIG. 4H illustrates an optical device 480, which is similar to the optical device 450 except that the optical device 480 is located adjacently to, a layer 482 of carbon nanotubes so that light transmitted through the optical device 480 is transmitted through the layer 482 of carbon nanotubes or light transmitted through the layer 482 of carbon nanotubes is transmitted through the optical device 480. In some configurations, the layer 482 of carbon nanotubes operates as a color filter that compensates for a color tint of the optical device 480.

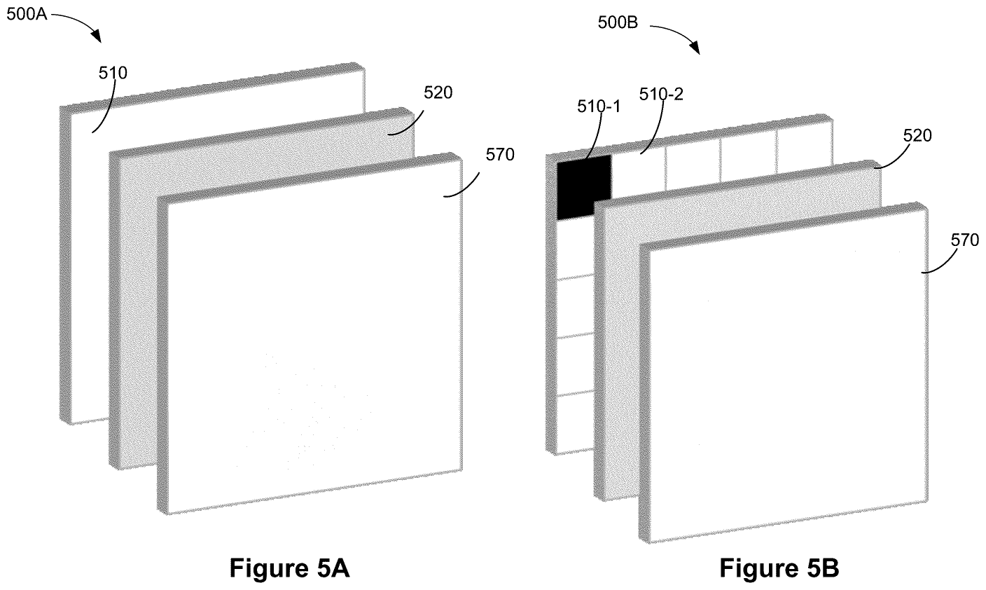

FIGS. 5A and 5B are schematic diagrams illustrating optical devices in accordance with some embodiments. In FIGS. 5A and 5B, optical devices are illustrated in exploded views to show components of such optical devices with clarity.

The optical devices shown in FIGS. 5A and 5B include a first transparent electrode 510, a second transparent electrode 570, and a medium 520.

FIG. 5A shows an optical device 500A with a single first optically dimmable filter, which corresponds to an optical device described with respect to FIGS. 1A-1B, 2A-2B, and 4A-4H, in accordance with some embodiments. The single first optically dimmable filter includes the first transparent electrode 510, the second transparent electrode 570 and the medium 520. In some embodiments, the sandwiched structure of the medium 520 between the two transparent electrodes (e.g., first transparent electrode 510 and the second transparent electrode 570) encompasses the entire display region for the augmented reality device. Uniform modulation of the optical properties associated with the display of the optical device with the single first optically dimmable filter is achievable when the first optically dimmable filter extends across a surface of the entire display region.

This allows the first optically dimmable filter to adjust the optical properties (e.g., transmittance) across an aperture of the optical device. For example, the optical properties of the optical device may be uniform across the entire aperture of the optical device.

In some other embodiments, the sandwiched medium 520 along with the two transparent electrodes can encompass only a portion of the display region for the optical device. This allows the first optically dimmable filter to adjust the optical properties (e.g., transmittance) across the portion of the aperture of the optical device. For example, the transmittance of the optical device will not be uniform across the entire aperture of the optical device. In some embodiments, the first optically dimmable filter extends substantially (e.g., at least 70%, 80%, 90%, or 95% but less than 100%) across a surface of the entire display region.

FIG. 5B shows an optical device 500B, which includes an array of optically dimmable filters (e.g., corresponding to electrodes 510-1 and 510-2). Each dimmable filter may correspond to an optical device described with respect to FIGS. 1A-1B, 2A-2B, and 4A-4H, in accordance with some embodiments. This allows the optical device 500B to adjust the optical properties for only a portion, less than all, of the aperture of the optical device. For example, an optically dimmable filter corresponding to the electrode 510-1 may be turned on while the optically dimmable filter corresponding to the electrode 510-2 may be turned off so that regions corresponding to the optically dimmable filter corresponding to the electrode 510-1 and the optically dimmable filter corresponding to the electrode 510-2 have different optical properties (e.g., transmittances). In some embodiments, respective optically dimmable filters in the array of optically dimmable filters are independently activatable (e.g., a particular optically dimmable filter may be turned on or off independently of whether the rest of the optically dimmable filters are turned on or off).

In some embodiments, a first voltage is provided to the optically dimmable filter corresponding to the electrode 510-1 while the optically dimmable filter corresponding to the electrode 510-1 is turned on and a second voltage, distinct from the first voltage, is provided the optically dimmable filter corresponding to the electrode 510-2 while the optically dimmable filter corresponding to the electrode 510-2 is turned on. This provides for different degrees of opaqueness (or transparency) that are controllable simultaneously and independently across at least a portion of the display region of the optical device.

In some embodiments, a first magnetic field is provided to the optically dimmable filter corresponding to the electrode 510-1 while the optically dimmable filter corresponding to the electrode 510-1 is turned on and a second magnetic field, distinct from the first magnetic field, is provided the optically dimmable filter corresponding to the electrode 510-2 while the optically dimmable filter corresponding to the electrode 510-2 is turned on. This provides for different degrees of opaqueness (or transparency) that are controllable simultaneously and independently across at least a portion of the display region of the optical device.

In some embodiments, the array of optically dimmable filters are arranged as pixels across the aperture of the optical device. In some embodiments, each pixel has a shape of a square having a size of 1 mm×1 mm, although the pixel may have a different size or shape (e.g., the pixel may be bigger or smaller, wider or narrower, taller or shorter, and may have a square shape, a non-square rectangular shape, or any other shape).

Although FIGS. 5A and 5B illustrate optical devices with a single layer of one or more optically dimmable filters, in some embodiments, the optical device includes a stack of two or more optically dimmable filter layers.

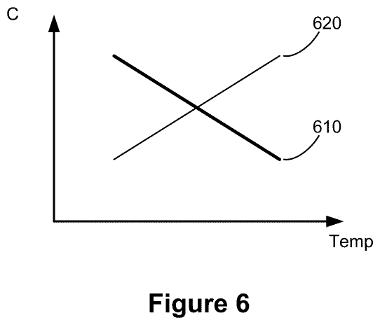

FIG. 6 is a prophetic example showing changes in optical contrast provided by photochromic materials and carbon nanotubes.

In some configurations, photochromic materials have a high disorder at a high temperature. Thus, increasing a temperature of photochromic materials reduces the transmittance and the contrast (C) of the photochromic materials (e.g., curve 610).

In comparison, the contrast (C) provided by lyotropic carbon nanotubes increases with an increasing temperature (e.g., curve 620). Thus, in an optical device that includes both photochromic materials and carbon nanotubes (e.g., the optical device 400), the carbon nanotubes compensates for the reduced contrast in the photochromic materials. This reduces the temperature dependence of the optical device. The amount of carbon nanotubes may be adjusted to increase compensation of the temperature dependence in the photochromic materials by the carbon nanotubes. Although the curves 610 and 620 are illustrated as straight lines in FIG. 6, the curve 610 or 620 may have a non-straight line.

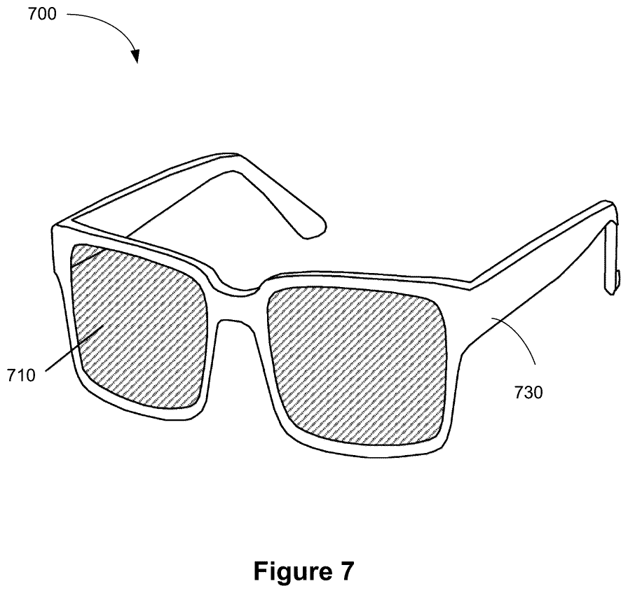

In some embodiments, optical devices described with respect to FIGS. 1A-1B, 2A-2B, and 4A-4H are used in display devices such as head-mounted display devices. In some embodiments, such optical devices may be implemented as multifunctional optical components in near-eye displays for augmented reality (“AR”), virtual reality (“VR”), and/or mixed reality (“MR”). For example, the disclosed optical elements or devices may be implemented as optical dimming elements (e.g., variable intensity filters), etc., which may significantly reduce the weight and size, and enhance the optical performance of the head-mounted display devices. Example embodiments of head-mounted display devices for implementing such optical devices are described with respect to FIGS. 7-9.

FIG. 7 illustrates display device 700 in accordance with some embodiments. In some embodiments, display device 700 is configured to be worn on a head of a user (e.g., by having the form of spectacles or eyeglasses, as shown in FIG. 7) or to be included as part of a helmet that is to be worn by the user. When display device 700 is configured to be worn on a head of a user or to be included as part of a helmet, display device 700 is called a head-mounted display or a wearable display. Alternatively, display device 700 is configured for placement in proximity of an eye or eyes of the user at a fixed location, without being head-mounted (e.g., display device 700 is mounted in a vehicle, such as a car or an airplane, for placement in front of an eye or eyes of the user). As shown in FIG. 7, display device 700 includes display 710. Display 710 is configured for presenting visual contents (e.g., augmented reality contents, virtual reality contents, mixed reality contents, or any combination thereof) to a user.

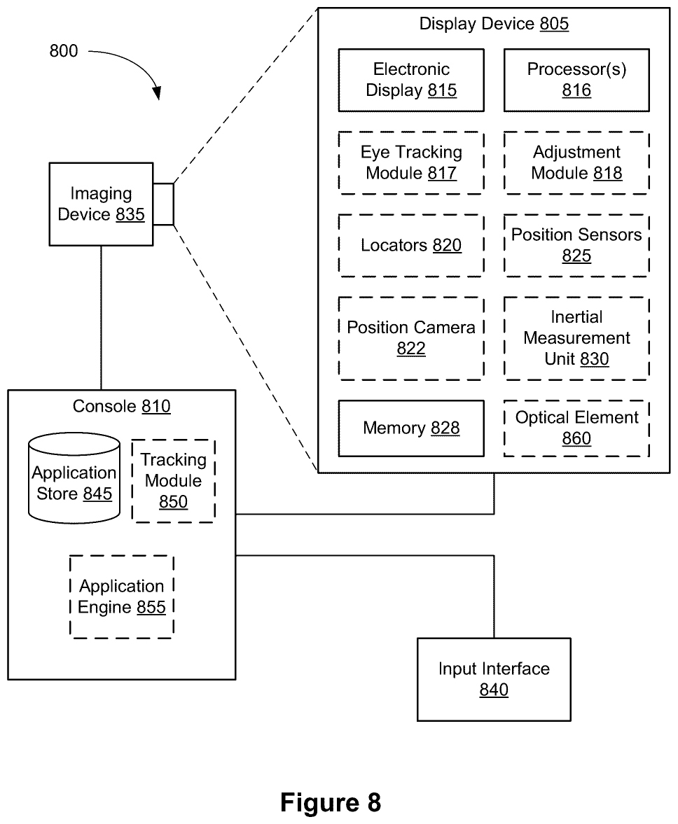

In some embodiments, display device 700 includes one or more components described herein with respect to FIG. 8. In some embodiments, display device 700 includes additional components not shown in FIG. 8.

FIG. 8 is a block diagram of system 800 in accordance with some embodiments. The system 800 shown in FIG. 8 includes display device 805, imaging device 835, and input interface 840 that are each coupled to console 810. While FIG. 8 shows an example of system 800 including one display device 805, imaging device 835, and input interface 840, in other embodiments, any number of these components may be included in system 800. For example, there may be multiple display devices 805 each having associated input interface 840 and being monitored by one or more imaging devices 835, with each display device 805, input interface 840, and imaging devices 835 communicating with console 810. In alternative configurations, different and/or additional components may be included in system 800. For example, in some embodiments, console 810 is connected via a network (e.g., the Internet or a wireless network) to system 800 or is self-contained as part of display device 805 (e.g., physically located inside display device 805). In some embodiments, display device 805 is used to create mixed reality by adding in a view of the real surroundings. Thus, display device 805 and system 800 described here can deliver augmented reality, virtual reality, and mixed reality.

In some embodiments, as shown in FIG. 7, display device 805 is a head-mounted display that presents media to a user. Examples of media presented by display device 805 include one or more images, video, audio, or some combination thereof. In some embodiments, audio is presented via an external device (e.g., speakers and/or headphones) that receives audio information from display device 805, console 810, or both, and presents audio data based on the audio information. In some embodiments, display device 805 immerses a user in an augmented environment.

In some embodiments, display device 805 also acts as an augmented reality (AR) headset. In these embodiments, display device 805 augments views of a physical, real-world environment with computer-generated elements (e.g., images, video, sound, etc.). Moreover, in some embodiments, display device 805 is able to cycle between different types of operation. Thus, display device 805 operate as a virtual reality (VR) device, an augmented reality (AR) device, as glasses or some combination thereof (e.g., glasses with no optical correction, glasses optically corrected for the user, sunglasses, or some combination thereof) based on instructions from application engine 855.

Display device 805 includes electronic display 815, one or more processors 816, eye tracking module 817, adjustment module 818, one or more locators 820, one or more position sensors 825, one or more position cameras 822, memory 828, inertial measurement unit (IMU) 830, one or more optical elements 860 or a subset or superset thereof (e.g., display device 805 with electronic display 815, one or more processors 816, and memory 828, without any other listed components). Some embodiments of display device 805 have different modules than those described here. Similarly, the functions can be distributed among the modules in a different manner than is described here.

One or more processors 816 (e.g., processing units or cores) execute instructions stored in memory 828. Memory 828 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 828, or alternately the non-volatile memory device(s) within memory 828, includes a non-transitory computer readable storage medium. In some embodiments, memory 828 or the computer readable storage medium of memory 828 stores programs, modules and data structures, and/or instructions for displaying one or more images on electronic display 815.

Electronic display 815 displays images to the user in accordance with data received from console 810 and/or processor(s) 816. In various embodiments, electronic display 815 may comprise a single adjustable display element or multiple adjustable display elements (e.g., a display for each eye of a user). In some embodiments, electronic display 815 is configured to display images to the user by projecting the images onto one or more optical elements 860.

In some embodiments, the display element includes one or more light emission devices and a corresponding array of spatial light modulators. A spatial light modulator is an array of electro-optic pixels, opto-electronic pixels, some other array of devices that dynamically adjust the amount of light transmitted by each device, or some combination thereof. These pixels are placed behind one or more lenses. In some embodiments, the spatial light modulator is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The spatial light modulator is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array. In some embodiments, electronic display 815 projects images to one or more reflective elements 860, which reflect at least a portion of the light toward an eye of a user.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 805 (e.g., a user wearing display device 805) for viewing images from display device 805. In some cases, the eyebox is represented as a 10 mm×10 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed. As used herein, IR refers to light with wavelengths ranging from 700 nm to 1 mm including near infrared (NIR) ranging from 750 nm to 1500 nm.

Eye tracking module 817 determines locations of each pupil of a user's eyes. In some embodiments, eye tracking module 817 instructs electronic display 815 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 817 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 817 maps the locations of the user's pupil while looking at the reference points to corresponding signals received on the IR tracking array). As mentioned above, in some embodiments, system 800 may use other eye tracking systems than the embedded IR one described herein.

Adjustment module 818 generates an image frame based on the determined locations of the pupils. In some embodiments, this sends a discrete image to the display that will tile subimages together thus a coherent stitched image will appear on the back of the retina. Adjustment module 818 adjusts an output (i.e., the generated image frame) of electronic display 815 based on the detected locations of the pupils. Adjustment module 818 instructs portions of electronic display 815 to pass image light to the determined locations of the pupils. In some embodiments, adjustment module 818 also instructs the electronic display to not pass image light to positions other than the determined locations of the pupils. Adjustment module 818 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 820 are objects located in specific positions on display device 805 relative to one another and relative to a specific reference point on display device 805. A locator 820 may be a light emitting diode (LED), a corner cube reflector, a reflective marker, a type of light source that contrasts with an environment in which display device 805 operates, or some combination thereof. In embodiments where locators 820 are active (e.g., an LED or other type of light emitting device), locators 820 may emit light in the visible band (e.g., about 500 nm to 750 nm), in the infrared band (e.g., about 750 nm to 1 mm), in the ultraviolet band (about 100 nm to 500 nm), some other portion of the electromagnetic spectrum, or some combination thereof.

In some embodiments, locators 820 are located beneath an outer surface of display device 805, which is transparent to the wavelengths of light emitted or reflected by locators 820 or is thin enough to not substantially attenuate the wavelengths of light emitted or reflected by locators 820. Additionally, in some embodiments, the outer surface or other portions of display device 805 are opaque in the visible band of wavelengths of light. Thus, locators 820 may emit light in the IR band under an outer surface that is transparent in the IR band but opaque in the visible band.

IMU 830 is an electronic device that generates calibration data based on measurement signals received from one or more position sensors 825. Position sensor 825 generates one or more measurement signals in response to motion of display device 805. Examples of position sensors 825 include: one or more accelerometers, one or more gyroscopes, one or more magnetometers, another suitable type of sensor that detects motion, a type of sensor used for error correction of IMU 830, or some combination thereof. Position sensors 825 may be located external to IMU 830, internal to IMU 830, or some combination thereof.

Based on the one or more measurement signals from one or more position sensors 825, IMU 830 generates first calibration data indicating an estimated position of display device 805 relative to an initial position of display device 805. For example, position sensors 825 include multiple accelerometers to measure translational motion (forward/back, up/down, left/right) and multiple gyroscopes to measure rotational motion (e.g., pitch, yaw, roll). In some embodiments, IMU 830 rapidly samples the measurement signals and calculates the estimated position of display device 805 from the sampled data. For example, IMU 830 integrates the measurement signals received from the accelerometers over time to estimate a velocity vector and integrates the velocity vector over time to determine an estimated position of a reference point on display device 805. Alternatively, IMU 830 provides the sampled measurement signals to console 810, which determines the first calibration data. The reference point is a point that may be used to describe the position of display device 805. While the reference point may generally be defined as a point in space; however, in practice the reference point is defined as a point within display device 805 (e.g., a center of IMU 830).

In some embodiments, IMU 830 receives one or more calibration parameters from console 810. As further discussed below, the one or more calibration parameters are used to maintain tracking of display device 805. Based on a received calibration parameter, IMU 830 may adjust one or more IMU parameters (e.g., sample rate). In some embodiments, certain calibration parameters cause IMU 830 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 835 generates calibration data in accordance with calibration parameters received from console 810. Calibration data includes one or more images showing observed positions of locators 820 that are detectable by imaging device 835. In some embodiments, imaging device 835 includes one or more still cameras, one or more video cameras, any other device capable of capturing images including one or more locators 820, or some combination thereof. Additionally, imaging device 835 may include one or more filters (e.g., used to increase signal to noise ratio). Imaging device 835 is configured to optionally detect light emitted or reflected from locators 820 in a field of view of imaging device 835. In embodiments where locators 820 include passive elements (e.g., a retroreflector), imaging device 835 may include a light source that illuminates some or all of locators 820, which retro-reflect the light towards the light source in imaging device 835. Second calibration data is communicated from imaging device 835 to console 810, and imaging device 835 receives one or more calibration parameters from console 810 to adjust one or more imaging parameters (e.g., focal length, focus, frame rate, ISO, sensor temperature, shutter speed, aperture, etc.).

In some embodiments, display device 805 optionally includes one or more optical elements 880 (e.g., lenses, reflectors, gratings, etc.). In some embodiments, electronic display device 805 includes a single optical element 860 or multiple optical elements 860 (e.g., an optical element 860 for each eye of a user). In some embodiments, electronic display 815 projects computer-generated images on one or more optical elements 860, such as a reflective element, which, in turn, reflect the images toward an eye or eyes of a user. The computer-generated images include still images, animated images, and/or a combination thereof. The computer-generated images include objects that appear to be two-dimensional and/or three-dimensional objects. In some embodiments, one or more optical elements 860 are partially transparent (e.g., the one or more optical elements 860 have a transmittance of at least 15%, 20%, 25%, 30%, 35%, 50%, 55%, or 50%), which allows transmission of ambient light. In such embodiments, computer-generated images projected by electronic display 815 are superimposed with the transmitted ambient light (e.g., transmitted ambient image) to provide augmented reality images.

In some embodiments, one or more optical elements 860, or a subset there of, are positioned to modify light (e.g., ambient light) transmitted to electronic display 815. For example, the one or more optical elements 860 may include an optical dimmer to selectively reduce the intensity of light passing through the optical dimmer. In some embodiments, optical elements 860 include an optical device described above with respect to FIGS. 1A-1B, 2A-2B, and 4A-4H.

Input interface 840 is a device that allows a user to send action requests to console 810. An action request is a request to perform a particular action. For example, an action request may be to start or end an application or to perform a particular action within the application. Input interface 840 may include one or more input devices. Example input devices include: a keyboard, a mouse, a game controller, data from brain signals, data from other parts of the human body, or any other suitable device for receiving action requests and communicating the received action requests to console 810. An action request received by input interface 840 is communicated to console 810, which performs an action corresponding to the action request. In some embodiments, input interface 840 may provide haptic feedback to the user in accordance with instructions received from console 810. For example, haptic feedback is provided when an action request is received, or console 810 communicates instructions to input interface 840 causing input interface 840 to generate haptic feedback when console 810 performs an action.

Console 810 provides media to display device 805 for presentation to the user in accordance with information received from one or more of: imaging device 835, display device 805, and input interface 840. In the example shown in FIG. 8, console 810 includes application store 845, tracking module 850, and application engine 855. Some embodiments of console 810 have different modules than those described in conjunction with FIG. 8. Similarly, the functions further described herein may be distributed among components of console 810 in a different manner than is described here.

When application store 845 is included in console 810, application store 845 stores one or more applications for execution by console 810. An application is a group of instructions, that when executed by a processor, is used for generating content for presentation to the user. Content generated by the processor based on an application may be in response to inputs received from the user via movement of display device 805 or input interface 840. Examples of applications include: gaming applications, conferencing applications, video playback application, or other suitable applications.

When tracking module 850 is included in console 810, tracking module 850 calibrates system 800 using one or more calibration parameters and may adjust one or more calibration parameters to reduce error in determination of the position of display device 805. For example, tracking module 850 adjusts the focus of imaging device 835 to obtain a more accurate position for observed locators on display device 805. Moreover, calibration performed by tracking module 850 also accounts for information received from IMU 830. Additionally, if tracking of display device 805 is lost (e.g., imaging device 835 loses line of sight of at least a threshold number of locators 820), tracking module 850 re-calibrates some or all of system 800.

In some embodiments, tracking module 850 tracks movements of display device 805 using second calibration data from imaging device 835. For example, tracking module 850 determines positions of a reference point of display device 805 using observed locators from the second calibration data and a model of display device 805. In some embodiments, tracking module 850 also determines positions of a reference point of display device 805 using position information from the first calibration data. Additionally, in some embodiments, tracking module 850 may use portions of the first calibration data, the second calibration data, or some combination thereof, to predict a future location of display device 805. Tracking module 850 provides the estimated or predicted future position of display device 805 to application engine 855.

Application engine 855 executes applications within system 800 and receives position information, acceleration information, velocity information, predicted future positions, or some combination thereof of display device 805 from tracking module 850. Based on the received information, application engine 855 determines content to provide to display device 805 for presentation to the user. For example, if the received information indicates that the user has looked to the left, application engine 855 generates content for display device 805 that mirrors the user's movement in an augmented environment. Additionally, application engine 855 performs an action within an application executing on console 810 in response to an action request received from input interface 840 and provides feedback to the user that the action was performed. The provided feedback may be visual or audible feedback via display device 805 or haptic feedback via input interface 840.

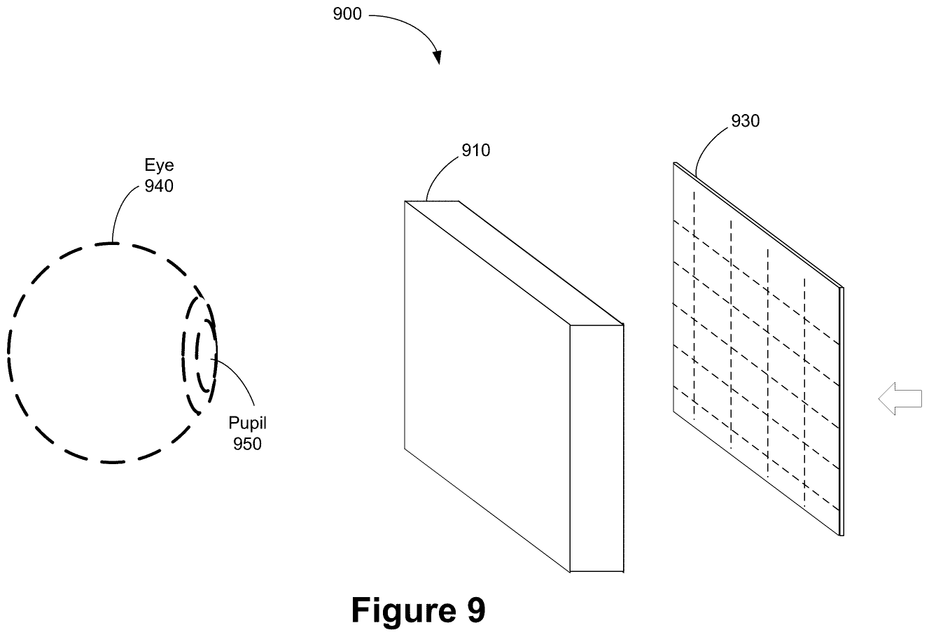

FIG. 9 is an isometric view of display device 900 in accordance with some embodiments. In some other embodiments, display device 900 is part of some other electronic display (e.g., a digital microscope, a head-mounted display device, etc.). In some embodiments, display device 900 includes light emission device 910 (e.g., a light emission device array) and an optical assembly 930, which may include one or more lenses and/or other optical components. In some embodiments, display device 900 also includes an IR detector array.

Light emission device 910 emits image light and optional IR light toward the viewing user. Light emission device 910 includes one or more light emission components that emit light in the visible light (and optionally includes components that emit light in the IR). Light emission device 910 may include, e.g., an array of LEDs, an array of microLEDs, an array of organic LEDs (OLEDs), an array of superluminescent LEDs (sLEDS) or some combination thereof.

In some embodiments, light emission device 910 includes an emission intensity array (e.g., a spatial light modulator) configured to selectively attenuate light emitted from light emission device 910. In some embodiments, the emission intensity array is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to no attenuation, while other liquid crystal cells may be set to maximum attenuation. In this manner, the emission intensity array is able to provide image light and/or control what portion of the image light is transmitted. In some embodiments, display device 900 uses the emission intensity array to facilitate providing image light to a location of pupil 950 of eye 940 of a user, and minimize the amount of image light provided to other areas in the eyebox. In some embodiments, display device 900 includes, or is optically coupled with, electro-optic devices operating as a display resolution enhancement component. In some embodiments, display device 900 is an augmented reality display device. In such embodiments, display device 900 includes, or is optically coupled with, electro-optic devices operating as a waveguide-based combiner or as a polarization selective reflector.

In some embodiments, the display device 900 includes one or more lenses. The one or more lenses receive modified image light (e.g., attenuated light) from light emission device 910, and direct the modified image light to a location of pupil 950. The optical assembly may include additional optical components, such as color filters, mirrors, etc.

In some embodiments, the optical assembly 930 includes an optical device described above with respect to FIGS. 1A-1B, 2A-2B, and 4A-4H. The optical device has a variable transmittance (e.g., has a first transmittance curve at a first time and a second transmittance curve distinct from the first transmittance curve at a second time mutually exclusive from the first time). The optical device conditionally reduces intensity of light passing through the optical device. In some embodiments, the optical device has only a single window that has a uniform transmittance across the window at each time (e.g., the optical device operates as a single variable intensity filter). In some embodiments, the optical device has a plurality of regions, as shown in FIG. 9, where each region may have a transmittance independent of transmittances of other regions. For example, the optical device may include an array of the structure shown in any of FIGS. 1A-1B, 2A-2B, and 4A-4H.

An optional IR detector array detects IR light that has been retro-reflected from the retina of eye 940, a cornea of eye 940, a crystalline lens of eye 940, or some combination thereof. The IR detector array includes either a single IR sensor or a plurality of IR sensitive detectors (e.g., photodiodes). In some embodiments, the IR detector array is separate from light emission device 910. In some embodiments, the IR detector array is integrated into light emission device 910.

In some embodiments, light emission device 910 including an emission intensity array make up a display element. Alternatively, the display element includes light emission device 910 (e.g., when light emission device 910 includes individually adjustable pixels) without the emission intensity array. In some embodiments, the display element additionally includes the IR array. In some embodiments, in response to a determined location of pupil 950, the display element adjusts the emitted image light such that the light output by the display element is refracted by one or more lenses toward the determined location of pupil 950, and not toward other locations in the eyebox.

In some embodiments, display device 900 includes one or more broadband sources (e.g., one or more white LEDs) coupled with a plurality of color filters, in addition to, or instead of, light emission device 910.

In light of these principles and examples, we now turn to certain embodiments.

In accordance with some embodiments, an optical device (e.g., optical device 200) includes a first set of electrodes (e.g., electrode 210); a second set of electrodes (e.g., electrode 230) distinct and separate from the first set of electrodes; and a medium (e.g., medium 220) located between the first set of electrodes and the second set of electrodes. The medium including a mixture of: liquid crystals (e.g., liquid crystals 222); and magnetic microstructures (e.g., magnetic microstructures 224). The optical device also includes one or more magnetic field generators (e.g., magnetic source 270) for switchably providing a magnetic field for orienting the magnetic microrods in the medium independently from the orientations of the liquid crystals (e.g., FIGS. 1A-1B and 2A-2B).

In some embodiments, the magnetic microstructures are ferromagnetic microstructures.

In some embodiments, the magnetic microstructures include one or more selected from a group consisting of: gadolinium iron cobalt, cobalt-platinum multi-layers, iron-platinum:titanium dioxide, terbium scandium aluminum garnet, or Heusler compounds.

In some embodiments, the magnetic microstructures include one or more selected from a group consisting of: magnetic colored rods, magnetic colored platelets, magnetic pigments, and magnetic glass.

In some embodiments, a respective magnetic microstructure of the magnetic microstructures is encapsulated in a separate non-magnetic coating (e.g., coating 226).

In some embodiments, the one or more magnetic field generators include one or more meta resonators.

In accordance with some embodiments, a method includes providing, during a first time window, a first magnetic field to a mixture of liquid crystals and magnetic microstructures for orienting the magnetic microstructures in a first arrangement (e.g., FIG. 2A); and providing, during a second time window mutually exclusive to the first time window, a second magnetic field distinct from the first magnetic field to the optical device for orienting the magnetic microstructures in a second arrangement distinct from the first arrangement (e.g., FIG. 1A).

In some embodiments, the first magnetic field has a first field intensity (e.g., FIG. 2A) and the second magnetic field has a second field intensity less than the first field intensity (e.g., FIG. 1A). At least a majority of the magnetic microstructures in the first arrangement are aligned along a first direction (e.g., a horizontal direction in FIG. 2A) and at least a majority of the magnetic microstructures in the second arrangement are not aligned along the first direction (e.g., FIG. 1A).

In some embodiments, the method includes providing, at a third time window, a first electrical field to the mixture for orienting the liquid crystals in a third arrangement (e.g., FIG. 1A); and providing, at a fourth time window mutually exclusive to the third time window, a second electrical field distinct from the first electrical field to the mixture for orienting the liquid crystals in a fourth arrangement distinct from the third arrangement (e.g., FIG. 1B).

In some embodiments, the third time window (e.g., T3 in FIG. 3) partially, but not completely, overlaps with the first time window (e.g., T1) or the second time window (e.g., T2); and the fourth time window (e.g., T4) partially, but not completely, overlaps with the first time window or the second time window (e.g., T2).

In accordance with some embodiments, an optical device includes a switchable optical cell (e.g., the optical device 400 or a portion that includes the electrodes 210 and 230 and the medium 220); and carbon nanotubes (e.g., carbon nanotubes 404) located within the switchable optical cell.

In some embodiments, the switchable optical cell includes photochromic material (e.g., photochromic materials 402) and the carbon nanotubes (e.g., the carbon nanotubes 404 are located within a switchable optical cell that includes the electrodes 210 and 230 and the medium 220).

In some embodiments, the carbon nanotubes are lyotropic carbon nanotubes.

In some embodiments, the carbon nanotubes are arranged for heat dissipation from the photochromic material.

In some embodiments, the switchable optical cell includes: a first set of electrodes (e.g., electrode 210); a second set of electrodes (e.g., electrode 230) distinct and separate from the first set of electrodes; and liquid crystals (e.g., liquid crystals 222) located between the first set of electrodes and the second set of electrodes. The liquid crystals are mixed with the carbon nanotubes so that while the switchable optical cell is in a first mode, a first electrical field is applied between the first set of electrodes and the second set of electrodes so that the liquid crystals are oriented in a first manner (e.g., FIG. 4C), and while the switchable optical cell is in a second mode, a second electrical field distinct from the first electrical field is applied between the first set of electrodes and the second set of electrodes so that the liquid crystals are oriented in a second manner distinct from the first manner (e.g., FIG. 4D).

In some embodiments, respective carbon nanotubes are coupled with the liquid crystals so that the carbon nanotubes are oriented in a third manner while the liquid crystals are arranged in the first manner, and the carbon nanotubes are oriented in a fourth manner distinct from the third manner while the liquid crystals are arranged in the second manner (e.g., FIGS. 4C and 4D).

In some embodiments, the switchable optical cell includes at least a first set of electrodes that include the carbon nanotubes (e.g., FIG. 4E).

In some embodiments, the first set of electrodes includes a first dielectric layer, a second dielectric layer distinct and separate from the first dielectric layer, and a layer of carbon nanotubes between the first dielectric layer and the second dielectric layer (e.g., FIG. 4F).

In some embodiments, the optical device includes an antenna (e.g., antenna 472) that includes the carbon nanotubes. In some embodiments, the antenna is optically transparent. This allows the antenna to be placed in an optical path of the optical device.

In some embodiments, the carbon nanotubes are arranged in a layer (e.g., layer 482) and positioned to receive light transmitted through the switchable optical cell or provide light transmitted through the layer to the switchable optical cell for compensating for a color tint of the switchable optical cell (e.g., FIG. 4H).

Although head-mounted displays are illustrated as apparatus that include the described optical devices, such optical devices may be used in other systems, devices, and apparatus. For example, the optical devices described herein may be used in augmented reality devices and applications.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

The terms “first state” and “second state” refer to different states, and do not indicate a particular sequence of the states or transitions. In addition, “first state” could be called “second state” and “second state” could be called “first state.”

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Although various drawings illustrate operations of particular components or particular groups of components with respect to one eye, a person having ordinary skill in the art would understand that analogous operations can be performed with respect to the other eye or both eyes. For brevity, such details are not repeated herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An optical device, comprising:
a first set of electrodes;
a second set of electrodes distinct and separate from the first set of electrodes;
a medium located between the first set of electrodes and the second set of electrodes, the medium including a mixture of:
liquid crystals; and
magnetic microstructures; and
one or more magnetic field generators for switchably providing a magnetic field for orienting the magnetic microrods in the medium independently from the orientations of the liquid crystals.

2. The optical device of claim 1, wherein the magnetic microstructures are ferromagnetic microstructures.

3. The optical device of claim 1, wherein:
the magnetic microstructures include one or more selected from a group consisting of: gadolinium iron cobalt, cobalt-platinum multi-layers, iron-platinum:titanium dioxide, terbium scandium aluminum garnet, or Heusler compounds.

4. The optical device of claim 1, wherein:
the magnetic microstructures include one or more selected from a group consisting of: magnetic colored rods, magnetic colored platelets, magnetic pigments, and magnetic glass.

5. The optical device of claim 1, wherein:
a respective magnetic microstructure of the magnetic microstructures is encapsulated in a separate non-magnetic coating.

6. The optical device of claim 1, wherein:
the one or more magnetic field generators include one or more meta resonators.

7. A method, comprising:
providing, during a first time window, a first magnetic field to a mixture of liquid crystals and magnetic microstructures for orienting the magnetic microstructures in a first arrangement; and
providing, during a second time window mutually exclusive to the first time window, a second magnetic field distinct from the first magnetic field to the optical device for orienting the magnetic microstructures in a second arrangement distinct from the first arrangement.

8. The method of claim 7, wherein:
the first magnetic field has a first field intensity and the second magnetic field has a second field intensity less than the first field intensity; and
at least a majority of the magnetic microstructures in the first arrangement are aligned along a first direction and at least a majority of the magnetic microstructures in the second arrangement are not aligned along the first direction.

9. The method of claim 7, further comprising:
providing, at a third time window, a first electrical field to the mixture for orienting the liquid crystals in a third arrangement; and
providing, at a fourth time window mutually exclusive to the third time window, a second electrical field distinct from the first electrical field to the mixture for orienting the liquid crystals in a fourth arrangement distinct from the third arrangement.

10. The method of claim 9, wherein:
the third time window partially, but not completely, overlaps with the first time window or the second time window; and
the fourth time window partially, but not completely, overlaps with the first time window or the second time window.

11. An optical device, comprising:
a switchable optical cell; and
carbon nanotubes located within the switchable optical cell.

12. The optical device of claim 11, wherein:
the switchable optical cell includes photochromic material and the carbon nanotubes.

13. The optical device of claim 12, wherein:
the carbon nanotubes are lyotropic carbon nanotubes.

14. The optical device of claim 12, wherein:
the carbon nanotubes are arranged for heat dissipation from the photochromic material.

15. The optical device of claim 11, wherein:
the switchable optical cell includes:
a first set of electrodes;
a second set of electrodes distinct and separate from the first set of electrodes; and
liquid crystals located between the first set of electrodes and the second set of electrodes, wherein the liquid crystals are mixed with the carbon nanotubes so that while the switchable optical cell is in a first mode, a first electrical field is applied between the first set of electrodes and the second set of electrodes so that the liquid crystals are oriented in a first manner, and while the switchable optical cell is in a second mode, a second electrical field distinct from the first electrical field is applied between the first set of electrodes and the second set of electrodes so that the liquid crystals are oriented in a second manner distinct from the first manner.

16. The optical device of claim 15, wherein:
respective carbon nanotubes are coupled with the liquid crystals so that the carbon nanotubes are oriented in a third manner while the liquid crystals are arranged in the first manner, and the carbon nanotubes are oriented in a fourth manner distinct from the third manner while the liquid crystals are arranged in the second manner.

17. The optical device of claim 11, wherein:
the switchable optical cell includes at least a first set of electrodes that include the carbon nanotubes.

18. The optical device of claim 11, wherein:
the first set of electrodes includes a first dielectric layer, a second dielectric layer distinct and separate from the first dielectric layer, and a layer of carbon nanotubes between the first dielectric layer and the second dielectric layer.

19. The optical device of claim 11, including:
a transparent antenna that includes the carbon nanotubes.

20. The optical device of claim 11, wherein:
the carbon nanotubes are arranged in a layer and positioned to receive light transmitted through the switchable optical cell or provide light transmitted through the layer to the switchable optical cell for compensating for a color tint of the switchable optical cell.
